(19) United States
(12) Patent Application Publication
(10) Pub. No.: US 2008/0146758 A1
(43) Pub. Date: Jun. 19, 2008

(54) Low temperature cure repellents

(76) Inventors: Peter Michael Murphy, Chadds Ford, PA (US); Richard H. Goldbaum, Wilmington, DE (US); Andrew Joseph McCall, Marlton, NJ (US); Carolyn Sue Yatsko, Elkton, MD (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/638,916

(22) Filed: Dec. 14, 2006

(51) Int. Cl. C08F 220/22; B32B 27/04; B05D 3/00

(52) U.S. Cl. 526/245; 427/393.4; 442/79

(57) ABSTRACT

An improved method for treating fibrous substrates with a copolymer containing a fluorinated acrylate or fluorinated methacrylate to provide water repellency and alcohol repellency wherein the improvement comprises contacting the substrate with a composition of particular fluorinated copolymers followed by drying or curing without heating.

### FIELD OF THE INVENTION

The present invention relates to an improved method of treating fibrous substrates to provide water repellency and alcohol repellency with fluorinated (meth)acrylate copolymers which dry and cure at ambient temperature without oven curing at elevated temperature.

### BACKGROUND OF THE INVENTION

Various fluorinated polymer compositions are known to be useful as treating agents to provide surface effects to substrates. Most commercially available fluorinated polymers useful as treating agents for imparting repellency to substrates require oven drying and curing at about 140° C. to provide the desired repellency properties. These commercially available fluorinated polymers usually contain a perfluoroalkyl chain containing predominantly eight or more carbon atoms.

Poly(fluoroalkylacrylate)s containing perfluoroalkyl groups having less than six carbon atoms usually have poor dynamic water repellency. Koji Honda et al., “Molecular Aggregation Structure and Surface Properties of poly(fluoroalkylacrylate) Thin Films” Macromolecules (2005), 38(13), 5699-5705 teach that for perfluoroalkyl chains of greater than 8 carbons, orientation of the perfluoroalkyl groups, designated R_{f} groups, is maintained in a parallel configuration while for such chains having less than 6 carbons, reorientation occurs. This reorientation decreases surface properties such as contact angle. Thus shorter chain perfluoroalkyls have traditionally not been successful commercially.

Drying and curing of a treated substrate contributes to developing optimum performance of water/alcohol repellency. The curing process allows melt spreading of the repellent and orientation of the fluorochemical polymer. The drying and curing usually requires high temperature heat curing, according to Charles L. Strickler, in “Fluorochemical Repellent Finishes for Nonwovens”, Journal of Industrial Fabrics (1984), 3(2), 10-18.

U.S. Pat. No. 7,008,993 describes a composition for providing alcohol and water repellency comprising: (a) a cationic fluoroacrylate copolymer with a glass transition temperature near ambient temperature; (b) a cationic fluoroacrylate copolymer with a glass transition temperature of about 80° C. to about 100° C.; (c) a nonionic hydrophilic softener; and (d) an inorganic additive. The above composition does not provide sufficient low surface tension to treat a nonwoven fabric such as a polypropylene nonwoven or a polyethylene nonwoven.

It is desirable to have a method for providing water repellency and alcohol repellency to fibrous substrates which employs drying and curing at ambient temperature without oven curing at elevated temperature. Such a method requires less energy. It is desirable to have such a method which is particularly effective for nonwoven substrates which have a low glass transition temperature. The present invention provides such a method.

### SUMMARY OF THE INVENTION

The present invention comprises a method for treating fibrous substrates with a copolymer containing a fluorinated acrylate or fluorinated methacrylate to provide water repellency and alcohol repellency wherein the improvement comprises contacting the substrate with a composition comprising repeating units in any sequence of Formula 1, Formula 2, Formula 3, or Formula 4, followed by drying or curing without heating, wherein

### A. Formula 1 is

[R_{f}—X—Y—C(O)—CH—CH₂]ₖ—[R_{f}—X—Y—C(O)—CT-CH₂]ₐ—[CCl₂—CH₂]_{b}—[R¹—Y—C(O)—CZ-CH₂]ₚ— Formula 1

wherein

R_{f} is a straight or branched perfluoroalkyl group having 6 carbon atoms, or a mixture thereof, which is optionally interrupted by at least one oxygen atom,

X is an organic divalent linking group having from about 1 to about 20 carbon atoms, optionally containing a triazole, oxygen, nitrogen, or sulfur, or a combination thereof,

Y is O, S or N(R) wherein R is H or C₁ to C₂₀ alkyl,

T is a straight or branched alkyl group having from about 1 to about 4 carbon atoms, or halide,

k is a positive integer,

a is a zero or positive integer,

b is a zero or positive integer,

p is zero or a positive integer, and

Z is H, a straight, branched or cyclic alkyl group having from about 1 to about 10 carbon atoms, or halide,

R¹ is H, CₙH₂ₙ₊₁, CₙH₂ₙ₋₁, CₘH₂ₘ—CH(O)CH₂, [CH₂CH₂O]ᵢR², [CH₂CH(CH₃)O]ᵢR², [CₘH₂ₘ]N(R²)₂,

n is from about 8 to about 40,

m is 1 to about 40,

each R² is independently H, CH₂OH or CₛH_{2s+1,}

s is 0 to about 40, and

i is 1 to about 200,

provided that

1) the repeating unit of [R_{f}—X—Y—C(O)—CH—CH₂]ₖ— in Formula 1 is present at a minimum of about 7% by weight,

2) the total of repeating units [R_{f}—X—Y—C(O)—CH—CH₂]ₖ+[R_{f}—X—Y—C(O)—CT-CH₂]ₐ+[CCl₂—CH₂]_{b} is present at a minimum of about 70% by weight, and

3) the total of all repeating units, [R_{f}—X—Y—C(O)—CH—CH₂]ₖ+[R_{f}—X—Y—C(O)—CT-CH₂]ₐ+[CCl₂—CH₂]_{b}+[R¹—Y—C(O)—CZ-CH₂]ₚ+optional monomers, is 100% by weight;

### B. Formula 2 is

[R_{f}—X—Y—C(O)—C(CH₃)—CH₂]ₐ—[CCl₂—CH₂]_{b}—[CH₃(CH₂)₃CH(C₂H₅)CH₂—O—C(O)—CH—CH₂]_{q}—[R¹—Y—C(O)—CZ-CH₂]ₚ—

wherein
R_{f}, X, Y, Z, R¹, a, b, and p are each as defined in Formula 1, and

q is a positive integer,

provided that

1) the repeating unit of —[R_{f}—X—Y—C(O)—C(CH₃)—CH₂]ₐ— in Formula 2 is present at about 48% by weight,

2) the repeating units —[CCl₂—CH₂]_{b}— and the repeating unit

—[CH₃(CH₂)₃CH(C₂H₅)CH₂—O—C(O)—CH—CH₂]_{q}— in Formula 2 are each present at about 24% by weight, and

3) the total of all repeating units, [R_{f}—X—Y—C(O)—C(CH₃)—CH₂]ₐ+[CCl₂—CH₂]_{b}+[CH₃(CH₂)₃CH(C₂H₅)CH₂—O—C(O)—CH—CH₂]_{q}+[R¹—Y—C(O)—CZ-CH₂]ₚ— is 100% by weight;

### C. Formula 3 is

[R_{f}—X—Y—C(O)—C(CH₃)—CH₂]ₐ—[CCl₂—CH₂]_{b}—[CH₃(CH₂)₁₇—O—C(O)—C(CH₃)—CH₂]_{q}—[CH₃(CH₂)₁₇—O—C(O)—CH—CH₂]ₜ—[R¹—Y—C(O)—CZ-CH₂]ₚ—

wherein

R_{f}, X, Y, Z, R¹, a, b, and p are each defined as in Formula 1,

q is a positive integer, and

t is a positive integer,

provided that

1) the repeating unit of —[R_{f}—X—Y—C(O)—C(CH₃)—CH₂]ₐ— in Formula 3 is present at about 48% by weight,

2) the repeating unit —[CCl₂—CH₂]_{b}—, is present at about 24% by weight,

3) the repeating unit —[CH₃(CH₂)₁₇—O—C(O)—C(CH₃)—CH₂]_{q}— and the repeating unit —[CH₃(CH₂)₁₇—O—C(O)—CH—CH₂]ₜ— of Formula 3 are each present at about 12% by weight, and

4) the total of all repeating units, [R_{f}—X—Y—C(O)—C(CH₃)—CH₂]ₐ+[CCl₂—CH₂]_{b}+—[CH₃(CH₂)₁₇—O—C(O)—C(CH₃)—CH₂]_{q}+[CH₃(CH₂)₁₇—O—C(O)—CH—CH₂]ₜ+[R¹—Y—C(O)—CZ-CH₂]ₚ—, is 100% by weight; and

### D. Formula 4 is

[R_{f}—X—Y—C(O)—CH—CH₂]ₖ—[R_{f}—X—Y—C(O)—C(CH₃)—CH₂]ₐ—[CH₃(CH₂)₁₇—O—C(O)—C(CH₃)—CH₂]_{q}—[CH₃(CH₂)₁₇—O—C(O)—CH—CH₂]ₜ—[CH₃(CH₂)₃CH(C₂H₅)CH₂—O—C(O)—CH—CH₂]ᵤ—[CH₃(CH₂)₃CH(C₂H₅)CH₂—O—C(O)—C(CH₃)—CH₂]ᵥ—[R¹—Y—C(O)—CZ-CH₂]ₚ—

wherein

R_{f}, X, Y, Z and R¹, k, a, p are each defined as in Formula 1,

q is a positive integer,

t is a positive integer,

u is a positive integer, and

v is a positive integer,

provided that

1) the repeating unit [R_{f}—X—Y—C(O)—CH—CH₂]ₖ— and the repeating unit —[R_{f}—X—Y—C(O)—C(CH₃)—CH₂]ₐ— in Formula 4 are each present at about 32% by weight,

2) the repeating unit —[CH₃(CH₂)₁₇—O—C(O)—C(CH₃)—CH₂]_{q}—, the repeating unit —[CH₃(CH₂)₁₇—O—C(O)—CH—CH₂]ₜ—, the repeating unit —[CH₃(CH₂)₃CH(C₂H₅)CH₂—O—C(O)—CH—CH₂]ᵤ—, and the repeating unit —[CH₃(CH₂)₃CH(C₂H₅)CH₂—O—C(O)—C(CH₃)—CH₂]ᵥ— of Formula 4 are each present at about 8% by weight, and

3) the total of all repeating units, [R_{f}—X—Y—C(O)—CH—CH₂]ₖ+[R_{f}—X—Y—C(O)—C(CH₃)—CH₂]ₐ+[CH₃(CH₂)₁₇—O—C(O)—C(CH₃)—CH₂]_{q}+[CH₃(CH₂)₁₇—O—C(O)—CH—CH₂]ₜ+[CH₃(CH₂)₃CH(C₂H₅)CH₂—O—C(O)—CH—CH₂]ᵤ+[CH₃(CH₂)₃CH(C₂H₅)CH₂—O—C(O)—C(CH₃)—CH₂]ᵥ+[R¹—Y—C(O)—CZ-CH₂]ₚ—, is 100% by weight.

The present invention further comprises a substrate treated in accordance with the above method.

### DETAILED DESCRIPTION OF THE INVENTION

All trademarks are denoted herein by capitalization. In all instances herein, the term “(meth)acrylate” is used to denote either or both acrylate or methacrylate.

The term of “ambient temperature” is used herein to mean a temperature of from about 15° C. to about 25° C.

The present invention comprises an improved method of treating fibrous substrates, in particular nonwoven substrates having a low glass transition temperature, with a fluorinated (meth)acrylate copolymer to impart water repellency and alcohol repellency. In the improved method of the present invention the treated substrates are air dried and cured at ambient temperature.

The minimum thermal property of polymers to make good fibers and fabrics is a melting temperature, Tm, above ambient temperature; or else the polymer would not have the structural integrity to form fibers and fabrics. If the fabric reaches a temperature near or above its Tm during drying or curing, the fabric will lose many of its properties, such as air permeability, handle, and tensile strength. Between the glass transition temperature, Tg, and the Tm, the polymer fiber or fabric can be mechanically stressed to induce useful properties, such as bulk, creases, dimensional strength, uniformity and other properties. Drying or curing at temperatures approaching the Tm risks losing these beneficial properties imparted to the fiber or fabric in earlier processing. Examples of Tg and Tm for various polymers are listed below.

| Polymer | Glass transition temperature (Tg) | Melting point (Tm) |
|---|---|---|
| Poly-ethylene | −125 C. | 137 C. |
| Poly-isobutylene | −73 C. | 44 C. |
| Poly-propylene | −13 C. | 176 C. |
| Poly-vinyl | −18 C. | 200 C. |
| Chloride | | |
| Nylon-6 | 52 C. | 223 C. |
| Nylon-66 | 50 C. | 265 C. |
| Polyester (PET) | 69 C. | 270 C. |
| Polystyrene | 100 C. | 240 C. |

### This data is from J. Brandup, E. H. Immergut, “Polymer Handbook”, Chapter III, p. 1-193, Wiley-Interscience, New York, 1975. Further explanation is found in G. Odian, “Principles of Polymerization”, Wiley-Interscience, New York, 1981, p. 29-36

The method of the present invention is particularly suitable for treating polymers having a Tg near ambient temperature, especially polypropylene nonwoven fabrics and polyethylene nonwoven fabrics.

The fluorinated (meth)acrylate copolymers used in the present invention comprise repeating units in any sequence of Formula 1, Formula 2, Formula 3, and Formula 4, as defined below. The polymer sequence includes random, statistical, block, multiblock, gradient, or alternating. The weight percentages given herein for each of Formula 1, Formula 2, Formula 3 and Formula 4 are by weight of the copolymer.

Formula 1 is

[R_{f}—X—Y—C(O)—CH—CH₂]ₖ—R_{f}—X—Y—C(O)—CT-CH₂]ₐ—[CCl₂—CH₂]_{b}—[R¹—Y—C(O)—CZ-CH₂]ₚ—

wherein

R_{f} is a straight or branched perfluoroalkyl group having 6 carbon atoms, which is optionally interrupted by at least one oxygen atom, or a mixture of the straight or branched perfluoroalkyl groups having 6 carbon atoms, X is an organic divalent linking group having from about 1 to about 20 carbon atoms, optionally containing a triazole, oxygen, nitrogen, or sulfur, or a combination thereof,

Y is O, S or N(R) wherein R is H or a straight, branched or cyclic C₁ to C₂₀ alkyl group,

T is a straight or branched alkyl group having from about 1 to about 4 carbon atoms, or halide,

k is a positive integer,

a is a zero or positive integer,

b is a zero or positive integer,

p is zero or a positive integer, and

Z is H, a straight, branched or cyclic alkyl group having from about 1 to about 10 carbon atoms, or halide,

R¹ is H, CₙH₂ₙ₊₁, CₙH₂ₙ₋₁, CₘH₂ₘ—CH(O)CH₂, [CH₂CH₂O]ᵢR², [CH₂CH(CH₃)O]ᵢR², [CₘH₂ₘ]N(R²)₂,

n is from about 8 to about 40,

m is 1 to about 40,

R² is H, CH₂OH or CₛH₂ₛ₊₁,

s is 0 to about 40, and

i is 1 to about 200,

provided that

1) the repeating unit of [R_{f}—X—Y—C(O)—CH—CH₂]ₖ— in Formula 1 is present at a minimum of about 7% by weight,

2) the total of repeating units [R_{f}—X—Y—C(O)—CH—CH₂]ₖ+[R_{f}—X—Y—C(O)—CT-CH₂]ₐ+[CCl₂—CH₂]_{b} is present at a minimum of about 70% by weight, and

3) the total of all repeating units, [R_{f}—X—Y—C(O)—CH—CH₂]ₖ+[R_{f}—X—Y—C(O)—CT-CH₂]ₐ+[CCl₂—CH₂]_{b}+[R¹—Y—C(O)—CZ-CH₂]ₚ, plus any other optional monomers, is 100%.

In the Formula 1 copolymer the repeating unit [R_{f}—X—Y—C(O)—CT-CH₂]ₐ is present at a minimum of 7% by weight and can range up to 100% by weight, preferably from about 7% to about 97% by weight of the copolymer, more preferably from about 7% to about 50% by weight of the copolymer. In Formula 1 the total of repeating units [R_{f}—X—Y—C(O)—CH—CH₂]ₖ+[R_{f}—X—Y—C(O)—CT-CH₂]ₐ+[CCl₂—CH₂]_{b} is present at a minimum about 70% by weight. This total of repeating units [R_{f}—X—Y—C(O)—CH—CH₂]ₖ+[R_{f}—X—Y—C(O)—CT-CH₂]ₐ+[CCl₂—CH₂]_{b} is present at a range of from about 70% to 100% by weight of the copolymer used in the present invention. Preferably this total is present at from about 70% to about 90% by weight, more preferably from about 70% to 80% by weight. The total of all repeating units in Formula 1, plus any other optional monomers is 100% by weight.

Formula 2 is [R_{f}—X—Y—C(O)—C(CH₃)—CH₂]ₐ—[CCl₂—CH₂]_{b}—[CH₃(CH₂)₃CH(C₂H₅)CH₂—O—C(O)—CH—CH₂]_{q}—[R¹—Y—C(O)—CZ-CH₂]ₚ—

wherein

R_{f}, X, Y, Z, R¹, a, b, and p are each as defined in Formula 1, and

q is a positive integer,

provided that

1) the repeating unit of —[R_{f}—X—Y—C(O)—C(CH₃)—CH₂]ₐ— in Formula 2 is present at about 48% by weight,

2) the repeating unit —[CCl₂—CH₂]_{b}— and the repeating unit

—[CH₃(CH₂)₃CH(C₂H₅)CH₂—O—C(O)—CH—CH₂]_{q}— in Formula 2 are each present at about 24% by weight, and

3) the total of all repeating units, [R_{f}—X—Y—C(O)—C(CH₃)—CH₂]ₐ+[CCl₂—CH₂]_{b}+[CH₃(CH₂)₃CH(C₂H₅)CH₂—O—C(O)—CH—CH₂]_{q}+[R¹—Y—C(O)—CZ-CH₂]ₚ— is 100% by weight.

Formula 3 is

[R_{f}—X—Y—C(O)—C(CH₃)—CH₂]ₐ—[CCl₂—CH₂]_{b}—[CH₃(CH₂)₁₇—O—C(O)—C(CH₃)—CH₂]_{q}—[CH₃(CH₂)₁₇—O—C(O)—CH—CH₂]ₜ—[R¹—Y—C(O)—CZ-CH₂]ₚ—

wherein

R_{f}, X, Y, Z, R¹, a, b, and p are each defined as in Formula 1,

q is a positive integer, and

t is a positive integer,

provided that

1) the repeating unit of —[R_{f}—X—Y—C(O)—C(CH₃)—CH₂]ₐ in Formula 3 is present at about 48% by weight,

2) the repeating unit —[CCl₂—CH₂]_{b}—, is present at about 24% by weight,

3) the repeating unit —[CH₃(CH₂)₁₇—O—C(O)—C(CH₃)—CH₂]_{q}— and the repeating unit —[CH₃(CH₂)₁₇—O—C(O)—CH—CH₂]ₜ— of Formula 3 are each present at about 12% by weight, and

4) the total of all repeating units, [R_{f}—X—Y—C(O)—C(CH₃)—CH₂]ₐ+[CCl₂—CH₂]_{b}+[CH₃(CH₂)₁₇—O—C(O)—C(CH₃)—CH₂]_{q}+[CH₃(CH₂)₁₇—O—C(O)—CH—CH₂]ₜ+[R¹—Y—C(O)—CZ-CH₂]ₚ—, is 100% by weight.

Formula 4 is

[R_{f}—X—Y—C(O)—CH—CH₂]ₖ—[R_{f}—X—Y—C(O)—C(CH₃)—CH₂]ₐ—[CH₃(CH₂)₁₇—O—C(O)—C(CH₃)—CH₂]_{q}—[CH₃(CH₂)₁₇—O—C(O)—CH—CH₂]ₜ—[CH₃(CH₂)₃CH(C₂H₅)CH₂—O—C(O)—CH—CH₂]_{q}—[CH₃(CH₂)₃CH(C₂H₅)CH₂—O—C(O)—C(CH₃)—CH₂]ᵥ—[R¹—Y—C(O)—CZ-CH₂]ₚ—

wherein

R_{f}, X, Y, Z and R¹, k, a, p are each defined as in Formula 1,

q is a positive integer,

t is a positive integer,

u is a positive integer, and

v is a positive integer,

provided that

1) the repeating unit [R_{f}—X—Y—C(O)—CH—CH₂]ₖ— and the repeating unit —[R_{f}—X—Y—C(O)—C(CH₃)—CH₂]ₐ— in Formula 4 are each present at about 32% by weight,

2) the repeating unit —[CH₃(CH₂)₁₇—O—C(O)—C(CH₃)—CH₂]_{q}—, the repeating unit —[CH₃(CH₂)₁₇—O—C(O)—CH—CH₂]ₜ—, the repeating unit —[CH₃(CH₂)₃CH(C₂H₅)CH₂—O—C(O)—CH—CH₂]ᵤ—, and the repeating unit —[CH₃(CH₂)₃CH(C₂H₅)CH₂—O—C(O)—C(CH₃)—CH₂]ᵥ— of Formula 4 are each present at about 8% by weight, and

3) the total of all repeating units, [R_{f}—X—Y—C(O)—CH—CH₂]ₖ+[R_{f}—X—Y—C(O)—C(CH₃)—CH₂]ₐ+[CH₃(CH₂)₁₇—O—C(O)—C(CH₃)—CH₂]_{q}+[CH₃(CH₂)₁₇—O—C(O)—CH—CH₂]ₜ+[CH₃(CH₂)₃CH(C₂H₅)CH₂—O—C(O)—CH—CH₂]ᵤ+[CH₃(CH₂)₃CH(C₂H₅)CH₂—C(O)—C(CH₃)—CH₂]ᵥ+[R¹—Y—C(O)—CZ-CH₂]ₚ—, is 100% by weight.

In each of Formula 1 to 4, R_{f} is preferably a straight or branched perfluoroalkyl group having 6 carbon atoms, which is optionally interrupted by at least one oxygen atom, or a mixture of the straight or branched perfluoroalkyl groups having 6 carbon atoms. More preferably R_{f} is a straight or branched C₆F₁₃—, or a mixture thereof. Most preferably R_{f} is CF₃(CF₂)₅.

In Formula 1 to 4, the subscripts k, a, b, p, q, t, u, and v are each independently from 1 to about 10,000, more preferably from about 5 to about 2000, or a mixture thereof.

Examples of suitable linking groups X in Formula 1 to 4 include straight chain, branched chain or cyclic alkylene, phenyl, arylene, aralkylene, sulfonyl, sulfoxy, sulfonamido, carbonamido, carbonyloxy, urethanylene, ureylene, and combinations thereof such as sulfonamidoalkylene.

Examples of preferred groups Y in Formula 1 to 4 are O, S or N(R) wherein R is H or C₁ to C₄ alkyl.

The copolymers used in the present invention are prepared by polymerization of fluorinated (meth)acrylate monomers with other monomers as detailed below.

The copolymers of Formula 1 used in the present invention comprise monomers copolymerized in the following percentages by weight relative to the copolymer product:

(a) from about 7% to about 100% of Formula 5, or a mixture thereof

R_{f}—X—Y—C(O)—CH═CH₂ Formula 5

wherein

R_{f}, X and Y are defined as in Formula 1 above;

(b) from about 0% to about 93% of Formula 6, or a mixture of thereof:

R_{f}—X—Y—C(O)—CT=CH₂ Formula 6

wherein

R_{f}, X, Y and T are defined as in Formula 1 above;

c) from about 0% to about 93% of vinylidene chloride;

d) from about 0% to about 30% of Formula 7, or a mixture thereof:

R¹—Y—C(O)—CZ-CH₂ Formula 7

wherein

Y, R¹, and Z are each as defined as above in Formula 1; and

e) from about 0% to about 93% of an additional optional monomer. Thus the copolymer of Formula 1 can comprise repeating units derived from 100% of Formula 5; a mixture of Formula 5 and Formula 6; a mixture of Formula 5 and vinylidene chloride; a mixture of Formula 5 and Formula 7; a mixture of Formula 5 and an optional monomer; a mixture of Formula 5 and any two of Formula 6, Formula 7, vinylidene chloride, and an optional monomer; a mixture of Formula 5 and any three of Formula 6, Formula 7, vinylidene chloride, and an optional monomer; or a mixture of Formula 5, Formula 6, Formula 7, vinylidene chloride and an optional monomer. For any such mixture the weight percent of all repeating units adds up to 100%.

The copolymers of Formula 2 used in the present invention comprise monomers copolymerized in the following percentages by weight relative to the copolymer product:

(a) about 48% of Formula 8

R_{f}—X—Y—C(O)—C(CH₃)═CH₂ Formula 8

wherein

R_{f}, X and Y are defined as in Formula 1 above;

(b) about 24% of vinylidene chloride;

(c) about 24% of 2-ethylhexyl acrylate; and

(d) about 4% of Formula 7 as defined above.

The copolymers of Formula 3 used in the present invention comprise monomers copolymerized in the following percentages by weight relative to the copolymer product:

(a) about 48% of Formula 8

R_{f}—X—Y—C(O)—C(CH₃)═CH₂ Formula 8

wherein

R_{f}, X and Y are defined as in Formula 1 above;

(b) about 24% of vinylidene chloride;

(c) about 12% of stearyl methacrylate;

(d) about 12% of stearyl acrylate; and

(e) about 4% of Formula 7 as defined above.

The copolymers of Formula 4 used in the present invention comprise monomers copolymerized in the following percentages by weight relative to the copolymer product:

(a) about 32% of Formula 5 as defined above, or a mixture thereof,

(b) about 32% of Formula 8 as defined above, or a mixture of thereof,

(c) about 8% of stearyl methacrylate,

(d) about 8% of stearyl acrylate,

(e) about 8% of 2-ethylhexyl acrylate,

(f) about 8% of 2-ethylhexyl methacrylate, and

(g) about 4% of Formula 7 as defined above, or a mixture thereof.

In Formula 5 and Formula 8, R_{f} is preferably a straight or branched perfluoroalkyl group having 6 carbon atoms, or a mixture thereof, more preferably a straight or branched C₆F₁₃—, or a mixture thereof, most preferably CF₃(CF₂)₅—. Examples of Formula 5 suitable for use in the present invention are:

CF₃(CF₂)₅—CH₂CH₂—OC(O)—CH═CH₂,

C₆F₁₃—CH₂CH₂—OC(O)—CH═CH₂,

C₆F₁₃—R²—SC(O)—CH═CH₂,

C₆F₁₃—R²—OC(O)—CH═CH₂,

C₆F₁₃—SO₂—N(R¹)—R²—OC(O)—CH═CH₂,

C₆F₁₃—CO—N(R¹)—R²—OC(O)—CH═CH₂,

C₆F₁₃—CH₂CH(OR³)CH—OC(O)—CH═CH₂,

C₆F₁₃—R²—SO₂—N(R¹)—OC(O)—CH═CH₂,

C₆F₁₃—R²—O—CON(R¹)—R²—OC(O)—CH═CH₂,

wherein

R¹ is H or C₁-C₄ alkyl;

R² is C₁-C₁₀ alkylene; and

R³ is H or C₁-C₄ acyl.

Examples of suitable Formula 6 suitable for use in the present invention are:

CF₃(CF₂)_{5—}CH₂CH₂—OC(O)—C(CH₃)═CH₂,

C₆F_{13—}CH₂CH₂—OC(O)—C(CH₃)═CH₂,

C₆F₁₃—R²—SC(O)—C(CH₃)═CH₂,

C₆F₁₃—R²—OC(O)—C(CH₃)═CH₂,

C₆F₁₃—SO₂—N(R¹)—R²—OC(O)—C(CH₃)═CH₂,

C₆F₁₃—CO—N(R¹)—R²—OC(O)—C(CH₃)═CH₂,

C₆F₁₃—CH₂CH(OR³)CH—OC(O)—C(CH₃)═CH₂,

C₆F₁₃—R²—SO₂—N(R¹)—OC(O)—C(CH₃)═CH₂,

C₆F₁₃—R²—O—CON(R¹)—R²—OC(O)—C(CH₃)═CH₂,

wherein

R¹ is H or C₁-C₄ alkyl;

R² is C₁-C₁₀ alkylene; and

R³ is H or C₁-C₄ acyl.

Examples of Formula 8 suitable for use in the present invention are:

CF₃(CF₂)_{5—}CH₂CH₂—OC(O)—C(CH₃)═CH₂,

C₆F_{13—}CH₂CH₂—OC(O)—C(CH₃)═CH₂,

C₆F₁₃—R²—SC(O)—C(CH₃)═CH₂,

C₆F₁₃—R²—OC(O)—C(CH₃)═CH₂,

C₆F₁₃—SO₂—N(R¹)—R²—OC(O)—C(CH₃)═CH₂,

C₆F₁₃—CO—N(R¹)—R²—OC(O)—C(CH₃)═CH₂,

C₆F₁₃—CH₂CH(OR³)CH—OC(O)—C(CH₃)═CH₂,

C₆F₁₃—R²—SO₂—N(R¹)—OC(O)—C(CH₃)═CH₂,

C₆F₁₃—R²—O—CON(R¹)—R²—OC(O)—C(CH₃)═CH₂,

wherein

R¹ is H or C₁-C₄ alkyl;

R² is C₁-C₁₀ alkylene; and

R³ is H or C₁-C₄ acyl.

The nonfluorinated (meth)acrylate monomers as of Formula 7 suitable for the use in the method of the present invention comprise alkyl (meth)acrylates in which the alkyl group is a straight or branched chain containing 8 to 40 carbon atoms, or mixtures thereof. The preferred alkyl group for the alkyl (meth)acrylates containing 8 to 20 carbon atoms. The alkyl (meth)acrylates (linear or branched) are exemplified by, but not limited to, alkyl(meth)acrylates where the alkyl group is octyl, 2-ethylhexyl, decyl, isodecyl, lauryl, cetyl, or stearyl. The preferred examples are 2-ethylhexyl acrylate, lauryl acrylate and stearyl acrylate.

Examples of other nonfluorinated (meth)acrylate monomers as of Formula 7 suitable for the use in the present invention include N-methylol (meth)acrylates, hydroxyalkyl (meth)acrylates, alkyloxy(meth)acrylates, glycidyl (meth)acrylates, stearyl acrylate, aminoalkyl methacrylate hydrochloride, acrylamide, alkyl acrylamide. Wherein, N-methylol monomers are exemplified by, but not limited to N-methylolacrylamide and N-methylolmethacrylamide. The hydroxyalkyl (meth)acrylates have alkyl chain lengths in the range between 2 and 4 carbon atoms, and are exemplified by 2-hydroxyethyl acrylate, and 2-hydroxyethyl methacrylate. The alkyloxy(meth)acrylates also have alkyl chain lengths in the range between 2 and 4 carbon atoms, and contain between 1 and 12 oxyalkylene units per molecule, preferably between 4 and 10 oxyalkylene units per molecule, and most preferably between 6 and 8 oxyalkylene units per molecule.

Other suitable additional optional monomers for use in the preparation of the copolymers of Formula 1 include vinyl acetate, vinyl stearate, alkyl vinyl sulfone, styrene, vinyl benzoic acid, alkyl vinyl ether, maleic anhydride, vinyl chloride, and other olefin.

The fluorinated (meth)acrylate copolymers of Formula 1, 2, 3 or 4 used in this invention are prepared in organic solvent or water with one or more surfactants by free radical initiated polymerization of a mixture of fluorinated (meth)acrylate of Formula 5, 6 and/or 8, as appropriate, with the other monomers as listed above for each. The fluorinated copolymers used in this invention are made by agitating the monomers described above in organic solvent or water with one or more surfactants in a suitable reaction vessel which is equipped with an agitation device and an external heating and cooling device. A free radical initiator is added and the temperature raised to from about 20° to about 70° C. The polymerization initiator is exemplified by 2,2′-azobis(2-amidinopropane dihydrochloride or 2,2′-azobis(isobutyramidine) dihydrochloride. These initiators are sold by E. I. du Pont de Nemours and Company, Wilmington, Del., commercially under the name of “VAZO”. An example of a suitable polymerization regulator or chain transfer agent is dodecylmercaptan. Suitable organic solvents useful in the preparation of the copolymers of Formula 1, 2, 3 or 4 used in the method of the present invention include tetrahydrofuran, acetone, methyl isobutyl ketone, isopropanol, ethyl acetate, and mixtures thereof. Tetrahydrofuran is preferred. The reaction is conducted under an inert gas, such as nitrogen, to the exclusion of oxygen. The polymer is isolated by precipitation, and optionally purified by for example, recrystallization. The solvent is removed by evaporation, or the solution is retained for dilution and application to the substrate. The product of the reaction is a fluorinated (meth)acrylate copolymer of Formula 1, 2, 3 or 4.

The resulting fluorinated (meth)acrylate copolymer of Formula 1, 2, 3 or 4 then can be diluted with water, or further dispersed or dissolved in a solvent selected from the groups comprising simple alcohols and ketones that are suitable as the solvent for final application to substrates (hereinafter the “application solvent”). Alternatively, an aqueous dispersion, made by conventional methods with surfactants, is prepared by removing solvents by evaporation and the use of emulsification or homogenization procedures known to those skilled in the art. Such solvent-free emulsions are preferred to minimize flammability and volatile organic compounds (VOC) concerns. The final product for application to a substrate is a dispersion (if water based) or a solution (if a solvent other than water is used) of the fluorinated (meth)acrylate copolymer of Formula 1, 2, 3 or 4.

In the improved method of the present invention water repellency and alcohol repellency are provided to a fibrous substrate by contacting the fluorinated (meth)acrylate copolymer solution or dispersion of Formula 1, 2, 3 or 4 with the substrate. Suitable substrates include fibrous substrates, particularly nonwoven substrates as defined below.

The fluorinated (meth)acrylate copolymer solution or dispersion of Formula 1, 2 3 or 4 is contacted with the substrate by any suitable method. Such methods are known to those skilled in the art, and include for example, application by foam, nip, pad, kiss-roll, spray, dipping, immersion, brush, roller, sponge, mat, and similar conventional techniques. The fluorinated (meth)acrylate copolymer solution or dispersion of Formula 1, 2, 3 or 4 is applied to the substrate as such, or in combination with other optional textile finishes or surface treating agents.

Such optional additional components include treating agents or finishes to achieve additional surface effects, or additives commonly used with such agents or finishes. Such additional components comprise compounds or compositions that provide surface effects such as no iron, easy to iron, shrinkage control, wrinkle free, permanent press, moisture control, softness, strength, anti-slip, anti-static, anti-snag, anti-pill, stain repellency, stain release, alcohol repellency, alcohol release, water repellency, alcohol repellency, odor control, antimicrobial, sun protection, cleanability and similar effects. One or more of such treating agents or finishes can be applied to the substrate before, after, or simultaneously with the copolymer of the present invention. Such optional components are typically blended into the treatment bath.

Other additives commonly used with such treating agents or finishes can also be present such as surfactants, pH adjusters, cross linkers, wetting agents, wax extenders, and other additives known by those skilled in the art. Suitable surfactants include anionic, cationic, nonionic, N-oxides and amphoteric surfactants. Examples of such additives include processing aids, foaming agents, lubricants, anti-stains, and the like. Such additives are typically blended with the treatment bath

Application rates for the fluorinated (meth)acrylate copolymer solution or dispersion of Formula 1, 2, 3 or 4 used in the present invention depend on the substrate porosity and is an amount to provide the desired fluorine content in the treated substrate. A treated fibrous substrate typically has a fluorine content of from about 100 μg/g to about 10,000 μg/g by weight. Preferably the fluorine content is from about 1,000 μg/g to about 4,000 μg/g.

Optionally, nonfluorinated extender compositions are also included in the application composition to potentially increase fluorine efficiency. Examples of such optional additional extender polymer compositions are those disclosed in co-pending U.S. Provisional Application 60/607,612, filed Sep. 7, 2004 (CH2996), and in U.S. Ser. No. 11/175,680 filed Jul. 6, 2005 (CH3048).

The present invention further comprises substrates treated with the fluorinated (meth)acrylate copolymer solution or dispersion of Formula 1, 2, 3 or 4 using the method of the present invention. Suitable substrates include fibrous substrates. The fibrous substrates include woven, knit, and nonwoven fabrics or other textiles. In particular, the fluorinated (meth)acrylate copolymer solution or dispersion of Formula 1, 2, 3 or 4 used in the method of the present invention is suitable for providing excellent water repellency and alcohol repellency to woven, knit, and nonwoven fabrics, in particular those made from polyolefin fibers such as polypropylene, polyethylene, and low melting polymer blends, fibers made therefrom, and blends containing these fibers. The present invention is particularly suitable for polypropylene fabrics or polyethylene fabrics, and most particularly to polypropylene nonwoven fabrics or polyethylene nonwoven fabrics. The types of nonwoven fabrics include spun-bonded, melt-blown, and laminates containing either type of nonwoven structure. The types of nonwovens are described in the “Encyclopedia of Textile Finishing”, Rouette, Hans-Karl, 2001 Springer-Verlag, ISBN: 3540654909. Such nonwovens typically have a low glass transition temperature, and thus when conventional treating processes are employed with a heated curing step, the nonwoven softens during heating. Thus the improved method of the present invention permits providing surface effects to nonwovens without this disadvantage. The fluorinated (meth)acrylate copolymer solution or dispersion of Formula 1, 2 3 or 4 used in the method of the present invention provides excellent water and alcohol repellency to substrates treated therewith.

The fluorinated (meth)acrylate copolymer compositions used in the present invention are useful to provide excellent water repellency and alcohol repellency to treated substrates with air drying or curing at ambient temperature. Elevated temperatures are not required to obtain effective repellency. The fluorinated (meth)acrylate copolymers used in the method of the present invention allow for the use of shorter fluoroalkyl groups containing, for example, 6 carbon atoms while conventional commercially available (meth)acrylates typically show poor alcohol repellency and water repellency performance if the fluoroalkyl groups contain less than 8 carbon atoms.

### Test Methods

### Test Method 1

The fabric was treated with the copolymer dispersion for emulsion padding application using a pad bath (dipping) process. The fluorinated (meth)acrylate copolymer of Formula 1, 2, 3 or 4 was applied to spunbonded meltblown spunbonded polypropylene (SMS PP) nonwoven fabric manufactured by Kimberly-Clark (Roswell, Ga.) with a fabric weight of 76 grams/square meter. After application, the fabric was allowed to air dry and cure. The fabric was tested for water repellency and alcohol repellency using Test Methods 2 as described below.

### Test Method 2—Water/Alcohol Repellency

The water/alcohol repellency of a treated substrate was measured according to INDA Standard Test for Water/Alcohol Repellency Test Method, IST 80.6-92. The test determines the resistance of a treated substrate to wetting by aqueous liquids. Three drops of water-alcohol mixtures of varying surface tensions are placed on the substrate and the extent of surface wetting is determined visually.

The composition of water repellency test liquids is shown in table 1.

TABLE 1
Alcohol/Water Repellency Test Liquids

| Water Repellency | Volume % | Volume % |
|---|---|---|
| Rating Number | Isopropyl Alcohol | Distilled Water |
| 0 | 0 | 100 |
| 1 | 10 | 90 |
| 2 | 20 | 80 |
| 3 | 30 | 70 |
| 4 | 40 | 60 |
| 5 | 50 | 50 |
| 6 | 60 | 40 |
| 7 | 70 | 30 |
| 8 | 80 | 20 |
| 9 | 90 | 10 |
| 10 | 100 | 0 |

Three drops of Test Liquid 1 were placed on the treated substrate. If no liquid penetration or partial absorption (appearance of a darker wet patch on the substrate) was observed after 5 minutes, the test was repeated with Test Liquid 2. The test was repeated with Test Liquid 3 and progressively higher Test Liquid numbers until liquid penetration (appearance of a darker wet patch on the substrate) was observed. The test result was the highest Test Liquid number that did not penetrate into the substrate. Higher scores indicate greater repellency.

### EXAMPLES

For all Tables in the Examples section, measured fluorine is the weight ratio of fluorine to the weight of the entire treated fabric unless specified otherwise. All chemicals used in the following were reagent grade and were obtained from Sigma-Aldrich (St. Louis, Mo.) unless otherwise specified,

### Example 1

Into a plastic beaker were combined 200 grams of deionized water, 4.0 grams of Mazer MAPEG 600MS polyalkylene glycol esters from Mazer Chemicals, Inc., Gurnee, Ill., 6.0 grams of AVITEX surface active agents from E. I. du Pont de Nemours and Company, Wilmington, Del., 7.1 grams of CF₃(CF₂)₅CH₂CH₂OC(O)CHCH₂ which is available from E. I. du Pont de Nemours and Company, Wilmington, Del., 7.1 grams of CF₃(CF₂)₅CH₂CH₂—OC(O)C(CH₃)CH₂ which is available from E. I. du Pont de Nemours and Company, Wilmington, Del., 1.0 grams of poly(ethylene glycol) methacrylate having an average of 8 ethoxy groups (8EO-MA) available by the product name of BLEMMER 350, as a co-monomer, from NOF-America, White Plains, N.Y., 7.1 grams of stearyl methacrylate from Sigma-Aldrich, Milwaukee, Wis., 1.0 grams of hydroxymethyl acrylamide from Sigma-Aldrich, Milwaukee, Wis., 0.50 grams of hydroxy ethyl methacrylate from Sigma-Aldrich, Milwaukee, Wis., 0.25 grams of dodecyl mercaptan from Sigma-Aldrich, Milwaukee, Wis., 10.0 grams of hexylene glycol Sigma-Aldrich, Milwaukee, Wis., and 0.10 grams of sulfamic acid from Sigma-Aldrich, Milwaukee, Wis. The reaction mixture was heated to 55° C. and emulsified in a sonicator twice for two minutes until a uniform milky white emulsion resulted. The solution was charged to a 500 mL flask equipped a nitrogen blanket, condenser, overhead stirrer and temperature probe, set to nitrogen sparging, and stirred at 170 rpm. When the temperature had dropped below about 30° C. the flask was switched to nitrogen blanket and 14.3 grams of vinylidene chloride(VDC) from Sigma-Aldrich, Milwaukee, Wis. with 10.0 grams of deionized water were added. The solution was stirred for 15 minutes. After 15 minutes 0.50 grams of VAZO-50 initiator in 10.0 grams of deionized water was added. The reaction mixture was then heated to 50° C. over 30 min. The solution was stirred for 8 hours at 50° C. The solution was then cooled to room temperature and then filtered into a small necked bottle using gravity filtration through a milk filter to give an emulsion copolymer with 13.2% solids by weight and 3.2% fluorine by weight.

Spunbonded meltblown spunbonded polypropylene fabric (SMS PP) was treated with the copolymer in accordance with Test Method 1. The amount of fluorinated copolymer dispersion used in the pad bath was calculated to achieve a fluorine level on fabric of approximately 1200 micrograms per gram fluorine by weight. In addition to the fluorinated copolymer emulsion prepared as described above, the pad bath contained 0.15% by weight of ZELEC TY potassium butyl phosphate from E. I. du Pont de Nemours and Company, Wilmington, Del. and 0.6% of n-hexanol from Sigma-Aldrich, Milwaukee, Wis. After pad application of the fluorinated copolymer emulsion prepared as described above with a total bath wet pick up of approximately 140%, the nonwoven SMS PP fabric was either air dried or dried and cured in an oven until the fabric reached 140° C. and remained at that temperature for 3 minutes. The fabric was allowed to “rest” after treatment and cure. The nonwoven SMS PP fabric was tested for water repellency and alcohol repellency using Test Method 2. The results are in Table 2.

TABLE 2

| | Air Dry/Cure | |
|---|---|---|
| Example | at ambient temperature | 140° C. Dry/Cure |
| 1 | 8 | 9 |
| Untreated | 2 | 2 |

The data in Table 2 shows that the method of the present invention provided excellent water repellency and alcohol repellency on SMS PP nonwoven fabrics with air drying at ambient temperature which was substantially equivalent to use of drying at an elevated temperature.

### Examples 2-27 and Comparative Examples A-P

For each of Examples 2 to 27 and Comparative Examples A to P the copolymers were prepared using the monomers listed in Table 3 by weight percent in the copolymer, and using the procedure of Example 1. The resulting copolymers from Examples 2-27 and from Comparative Examples A-P were each applied using Test Method 1 to nonwoven spunbonded meltblown spunbonded polypropylene (SMS PP) fabrics. The treated fabrics were tested for water/alcohol repellency according to Test method 2. The results are in Table 5.

The Comparative Examples provided copolymer compositions that are outside of Formula 1, 2, 3 or 4 and did not provide ambient temperature cure repellency. For Comparative Examples A, F, J, K, L, M, and O, no repeating unit of [R_{f}—X—Y—C(O)—CH—CH₂]ₖ or of —[R_{f}—X—Y—C(O)—C(CH₃)—CH₂]ₐ is present. For Comparative Examples B, C, D, G, H, I, and P, the total of [R_{f}—X—Y—C(O)—CH—CH₂]ₖ+[R_{f}—X—Y—C(O)—CT-CH₂]ₐ+[CCl₂—CH₂]_{b} is less than 70% by weight. For Comparative Example E, R¹ is C₄H₉, a shorter chain length than required in Formula 1, 2, 3 or 4. For Comparative Example N, R¹ is C₆H₁₁, a shorter chain length than required in Formula 1, 2, 3 or 4.

TABLE 3
Monomers used in Copolymerization

| | Monomer* | | | | | | | | |
|---|---|---|---|---|---|---|---|---|---|
| Ex- | A | B | VDC | D | E | F | G | H | I |
| am- | Formula | | | | | | | | |
| ple | 5 | 6 | — | 7 | 7 | 7 | 7 | 7 | 7 |
| 2 | 19% | 19% | 39% | 19% | | | | | 4% |
| 3 | 7% | 18% | 50% | 21% | | | | | 4% |
| 4 | 38% | 24% | 30% | | | | | C₁₂ 4% | 4% |
| 5 | 48% | | 24% | 24% | | | | | 4% |
| 6 | 48% | | 24% | | 12% | 12% | | | 4% |
| 7 | 24% | 24% | 24% | 24% | | | | | 4% |
| 8 | 38% | | 38% | 9% | | | 10% | | 4% |
| 9 | 38% | | 38% | 19% | | | | | 4% |
| 10 | 48% | | 24% | 12% | | | 12% | | 4% |
| 11 | 38% | | 48% | | 10% | | | | 4% |
| 12 | 38% | | 38% | | 9% | 10% | | | 4% |
| 13 | 44% | | 31% | | | | 22% | | 4% |
| 14 | 58% | | 29% | | 10% | | | | 4% |
| 15 | 48% | | 24% | | 24% | | | | 4% |
| 16 | 19% | | 67% | | 10% | | | | 4% |
| 17 | 13% | 17% | 40% | | | | | branched | 4% |
| | | | | | | | | C₁₃ 26% | |
| 18 | 13% | 17% | 40% | | | | | C₁₈–C₂₄ | 4% |
| | | | | | | | | blend | |
| | | | | | | | | 26% | |
| 19 | 32% | | 42% | | 22% | | | | 4% |
| 20 | | 48% | 24% | | | 24% | | | 4% |
| 21 | | 48% | 24% | 12% | 12% | | | | 4% |
| 22 | 70% | | 10% | 16% | | | | | 4% |
| 23 | 44% | | 31% | | | 22% | | | 4% |
| 24 | 38% | 24% | 30% | | | | | branched | 4% |
| | | | | | | | | C₁₀ 4% | |
| 25 | 32% | 32% | | 8% | 8% | 8% | 8% | | 4% |
| 26 | 58% | | 19% | 19% | | | | | 4% |
| 27 | 24% | 26% | 46% | | | | | | 4% |
| A | | 44% | | | | | | C₁₂ 52% | 4% |
| B | 48% | | | 24% | | | 24% | | 4% |
| C | 64% | | | | | | 32% | | 4% |
| D | 38% | | 29% | | 29% | | | | 4% |
| E | 38% | 24% | 30% | | | | | C₄ 4% | 4% |
| F | | 64% | | | | 32% | | | 4% |
| G | 19% | | 48% | | 29% | | | | 4% |
| H | 44% | | | 52% | | | | | 4% |
| I | 44% | | | | 52% | | | | 4% |
| J | | 51% | 24% | | | | 21% | | 4% |
| K | | 38% | 38% | | | | 19% | | 4% |
| L | | 58% | 19% | 19% | | | | | 4% |
| M | | 36% | 36% | | | | 25% | | 4% |
| N | 13% | 17% | 40% | | | | | cyclic C₆ | 4% |
| | | | | | | | | 26% | |
| O | | 48% | 24% | | | | 24% | | 4% |
| P | 19% | | 29% | | 48% | | | | 4% |

*Monomer A - CF₃(CF₂)₅CH₂CH₂OC(O)CHCH₂
Monomer B - CF₃(CF₂)₅CH₂CH₂OC(O)C(CH₃)CH₂
Monomer VDC - vinylidene chloride
Monomer D - stearyl methacrylate
Monomer E - stearyl acrylate
Monomer F - 2-ethylhexyl acrylate
Monomer G - 2-ethylhexyl methacrylate
Monomer H - alkyl methacrylate
Monomer I - a mixture of 1.6% poly(ethylene glycol) methacrylate having an average of seven ethoxylates (7EO methacrylate), 1.0% hydroxyethyl methacrylate, 1.0% hydroxymethyl acrylamide, and 0.4% dodecyl mercaptan.

### Comparative Examples Q and R

For each of Comparative Example Q and Comparative Example R, the procedure of Example 1 was employed, but using as the fluorochemical a perfluoroalkylethyl acrylate mixture of the formula F(CF₂)ₐCH₂CH₂OC(O)CHCH₂, wherein a ranged from 4 to 12, and was predominately 6, 8, and 10. The typical mixture was as follows: 27% to 37% of a=6, 28% to 32% of a=8, 14% to 20% of a=10, 8% to 13% of a=12, and 3% to 6% of a=14, available from E. I. du Pont de Nemours and Company, Wilmington, Del. Thus for Comparative Examples Q and R, the group R_{f} is a blend of C₆F₁₃, C₈F₁₇, C₁₀F₂₁, C₁₂F₂₅, C₁₄F₂₉, which is outside of Formula 1, 2, 3 or 4. The monomers used are listed in Table 4 by weight percent of the copolymer. The resulting copolymers were each applied using Test Method 1 to nonwoven spunbonded meltblown spunbonded polypropylene SMS PP fabrics. The treated fabrics were tested for water/alcohol repellency according to Test method 2. The results are in Table 5.

TABLE 4
Monomers used in Copolymerization

| | | | Vinylidene | |
|---|---|---|---|---|
| Example No. | F(CF₂)ₐCH₂CH₂—OC(O)CHCH₂ | Stearyl methacrylate | chloride | I* |
| Comparative-Q | 19% | 29% | 48% | 4% |
| Comparative-R | 59% | 18% | 18% | 4% |

*Monomer I was a mixture of 1.6% poly(ethylene glycol) methacrylate having an average of seven ethoxylates (7EO methacrylate), 1.0% hydroxyethyl methacrylate, 1.0% hydroxymethyl acrylamide, and 0.4% dodecyl mercaptan.

TABLE 5
Water/Alcohol Repellency

| Example | Repellency |
|---|---|
| 2 | 8 |
| 3 | 8 |
| 4 | 8 |
| 5 | 8 |
| 6 | 8 |
| 7 | 8 |
| 8 | 8 |
| 9 | 7 |
| 10 | 7 |
| 11 | 7 |
| 12 | 7 |
| 13 | 6 |
| 14 | 6 |
| 15 | 6 |
| 16 | 6 |
| 17 | 6 |
| 18 | 5 |
| 19 | 5 |
| 20 | 5 |
| 21 | 5 |
| 22 | 5 |
| 23 | 5 |
| 24 | 4 |
| 25 | 4 |
| 26 | 4 |
| 27 | 3.5 |
| Comparative-A | 3 |
| Comparative-B | 3 |
| Comparative-C | 3 |
| Comparative-D | 2 |
| Comparative-E | 2 |
| Comparative-F | 2 |
| Comparative-G | 2 |
| Comparative-H | 2 |
| Comparative-I | 1 |
| Comparative-J | 1 |
| Comparative-K | 1 |
| Comparative-L | 1 |
| Comparative-M | 1 |
| Comparative-N | 1 |
| Comparative-O | 1 |
| Comparative-P | 0 |
| Comparative-Q | 1 |
| Comparative-R | 1 |
| Untreated | 2 |

In Table 5 Formula 1 is represented by Examples 1-19, 22-24, and 26-27. Formula 2 is represented by Example 20. Formula 3 is represented by Example 21. Formula 4 is represented by Example 25. The data in Table 5 shows that very high repellency was obtained in Examples 1 to 23, and moderate repellency in Examples 24 to 27. The Comparative Examples showed unacceptably low or no repellency.

What is claimed is:

1. A method for treating fibrous substrates with a copolymer containing a fluorinated acrylate or fluorinated methacrylate to provide water repellency and alcohol repellency wherein the improvement comprises contacting the substrate with a composition comprising repeating units in any sequence of Formula 1, Formula 2, Formula 3, or Formula 4, followed by drying or curing without heating, wherein
A. Formula 1 is
[R_{f}—X—Y—C(O)—CH—CH₂]ₖ—[R_{f}—X—Y—C(O)—CT-CH₂]ₐ—[CCl₂—CH₂]_{b}—[R¹—Y—C(O)—CZ-CH₂]ₚ— Formula 1
wherein
R_{f} is a straight or branched perfluoroalkyl group having 6 carbon atoms, or a mixture thereof, which is optionally interrupted by at least one oxygen atom,
X is an organic divalent linking group having from about 1 to about 20 carbon atoms, optionally containing a triazole, oxygen, nitrogen, or sulfur, or a combination thereof,
Y is O, S or N(R) wherein R is H or C₁ to C₂₀ alkyl,
T is a straight or branched alkyl group having from about 1 to about 4 carbon atoms, or halide,
k is a positive integer,
a is a zero or positive integer,
b is a zero or positive integer,
p is zero or a positive integer, and
Z is H, a straight, branched or cyclic alkyl group having from about 1 to about 10 carbon atoms, or halide,
R¹ is H, CₙH₂ₙ₊₁, CₙH₂ₙ₋₁, CₘH₂ₘ—-CH(O)CH₂, [CH₂CH₂O]ᵢR², [CH₂CH(CH₃)O]ᵢR², [CₘH₂ₘ]N(R¹)₂,
n is from about 8 to about 40,
m is 1 to about 40,
each R² is independently H, CH₂OH or CₛH_{2s+1,}
s is 0 to about 40, and
i is 1 to about 200,
provided that
1) the repeating unit of [R_{f}—X—Y—C(O)—CH—CH₂]ₖ— in Formula 1 is present at a minimum of about 7% by weight,
2) the total of repeating units [R_{f}—X—Y—C(O)—CH—CH₂]ₖ+[R_{f}—X—Y—C(O)—CT-CH₂]ₐ+[CCl₂—CH₂]_{b} is present at a minimum of about 70% by weight, and
3) the total of all repeating units, [R_{f}—X—Y—C(O)—CH—CH₂]ₖ+[R_{f}—X—Y—C(O)—CT-CH₂]ₐ+[CCl₂—CH₂]_{b}+[R¹—Y—C(O)—CZ-CH₂]ₚ+optional monomers, is 100% by weight;
B. Formula 2 is
[R_{f}—X—Y—C(O)—C(CH₃)—CH₂]ₐ—[CCl₂—CH₂]_{b}—[CH₃(CH₂)₃CH(C₂H₅)CH₂—O—C(O)—CH—CH₂]_{q}—[R¹—Y—C(O)—CZ-CH₂]ₚ—
wherein
R_{f}, X, Y, Z, R¹, a, b, and p are each as defined in Formula 1, and
q is a positive integer,
provided that
1) the repeating unit of —[R_{f}—X—Y—C(O)—C(CH₃)—CH₂]ₐ in Formula 2 is present at about 48% by weight,
2) the repeating unit —[CCl₂—CH₂]_{b}— and the repeating unit —[CH₃(CH₂)₃CH(C₂H₅)CH₂—O—C(O)—CH—CH₂]_{q}— in Formula 2 are each present at about 24% by weight, and
3) the total of all repeating unit, [R_{f}—X—Y—C(O)—C(CH₃)—CH₂]ₐ+[CCl₂—CH₂]_{b}+[CH₃(CH₂)₃CH(C₂H₅)CH₂—O—C(O)—CH—CH₂]_{q}+[R¹—Y—C(O)—CZ-CH₂]ₚ— is 100% by weight;
C. Formula 3 is
[R_{f}—X—Y—C(O)—C(CH₃)—CH₂]ₐ—[CCl₂—CH₂]_{b}—[CH₃(CH₂)₁₇—O—C(O)—C(CH₃)—CH₂]_{q}—[CH₃(CH₂)₁₇—O—C(O)—CH—CH₂]ₜ—[R¹—Y—C(O)—CZ-CH₂]ₚ—
wherein
R_{f}, X, Y, Z, R¹, a, b, and p are each defined as in Formula 1,
q is a positive integer, and
t is a positive integer,
provided that
1) the repeating unit of —[R_{f}—X—Y—C(O)—C(CH₃)—CH₂]ₐ— in Formula 3 is present at about 48% by weight,
2) the repeating unit —[CCl₂—CH₂]_{b}—, is present at about 24% by weight,
3) the repeating unit —[CH₃(CH₂)₁₇—O—C(O)—C(CH₃)—CH₂]_{q}— and the repeating unit —[CH₃(CH₂)₁₇—O—C(O)—CH—CH₂]ₜ— of Formula 3 are each present at about 12% by weight, and
4) the total of all repeating units, [R_{f}—X—Y—C(O)—C(CH₃)—CH₂]ₐ+[CCl₂—CH₂]_{b}+[CH₃(CH₂)₁₇—O—C(O)—C(CH₃)—CH₂]_{q}+[CH₃(CH₂)₁₇—O—C(O)—CH—CH₂]ₜ+[R¹—Y—C(O)—CZ-CH₂]ₚ—, is 100% by weight; and
D. Formula 4 is
[R_{f}—X—Y—C(O)—CH—CH₂]ₖ—[R_{f}—X—Y—C(O)—C(CH₃)—CH₂]ₐ—[CH₃(CH₂)₁₇—O—C(O)—C(CH₃)—CH₂]_{q}—[CH₃(CH₂)₁₇—O—C(O)—CH—CH₂]ₜ—[CH₃(CH₂)₃CH(C₂H₅)CH₂—O—C(O)—CH—CH₂]ᵤ—[CH₃(CH₂)₃CH(C₂H₅)CH₂—O—C(O)—C(CH₃)—CH₂]ᵥ—[R¹—Y—C(O)—CZ-CH₂]ₚ—
wherein
R_{f}, X, Y, Z and R¹, k, a, p are each defined as in Formula 1,
q is a positive integer,
t is a positive integer,
u is a positive integer, and
v is a positive integer,
provided that
1) the repeating unit [R_{f}—X—Y—C(O)—CH—CH₂]ₖ— and the repeating unit —[R_{f}—X—Y—C(O)—C(CH₃)—CH₂]ₐ— in Formula 4 are each present at about 32% by weight,
2) the repeating unit —[CH₃(CH₂)₁₇—O—C(O)—C(CH₃)—CH₂]_{q}—, the repeating unit —[CH₃(CH₂)₁₇—O—C(O)—CH—CH₂]ₜ—, the repeating unit —[CH₃(CH₂)₃CH(C₂H₅)CH₂—O—C(O)—CH—CH₂]ᵤ—, and the repeating unit —[CH₃(CH₂)₃CH(C₂H₅)CH₂—O—C(O)—C(CH₃)—CH₂]ᵥ— of Formula 4 are each present at about 8% by weight, and
3) the total of all repeating units, [R_{f}—X—Y—C(O)—CH—CH₂]ₖ+[R_{f}—X—Y—C(O)—C(CH₃)—CH₂]ₐ+[CH₃(CH₂)₁₇—O—C(O)—C(CH₃)—CH₂]_{q}+[CH₃(CH₂)₁₇—O—C(O)—CH—CH₂]ₜ+[CH₃(CH₂)₃CH(C₂H₅)CH₂—O—C(O)—CH—CH₂]ᵤ+[CH₃(CH₂)₃CH(C₂H₅)CH₂—C(O)—C(CH₃)—CH₂]ᵥ+[R¹—Y—C(O)—CZ-CH₂]ₚ—, is 100% by weight.

2. The method of claim 1 wherein the total of repeating units [R_{f}—X—Y—C(O)—CH—CH₂]ₖ+[R_{f}—X—Y—C(O)—CT-CH₂]ₐ+[CCl₂—CH₂]_{b} is present at from about 70% to 100% by weight of the copolymer.

3. The method of claim 1 wherein the total of repeating units [R_{f}—-X—Y—C(O)—CH—CH₂]ₖ+[R_{f}—X—Y—C(O)—CT-CH₂]ₐ+[CCl₂—CH₂]_{b} is present at from about 70% to about 90% by weight.

4. The method of claim 1 wherein the substrate, after treating, is air dried and cured at a temperature from about 15° C. to about 25° C.

5. The method of claim 1 wherein R_{f} is a straight or branched C₆F₁₃—.

6. The method of claim 1 wherein R_{f} is CF₃(CF₂)₅—.

7. The method of claim 1 wherein k, a, b, p, q, t, u and v are each independently from about 5 to about 2,000, or a mixture thereof.

8. The method of claim 1 wherein the composition is applied in the presence of at least one of
A) an agent which provides a surface effect which is no iron, easy to iron, shrinkage control, wrinkle free, permanent press, moisture control, softness, strength, anti-slip, antistatic, anti-snag, anti-pill, stain repellency, stain release, alcohol repellency, alcohol release, water repellency, alcohol repellency, odor control, antimicrobial, or sun protection,
B) a surfactant, antioxidant, light fastness agent, color fastness agent, water, pH adjuster, cross linker, wetting agent, extender, foaming agent, processing aid, lubricant, blocked isocyanate, nonfluorinated and extenders, or
C) combinations thereof.

9. The method of claim 1 wherein the composition of Formula 1 further comprises repeating units from optional monomers, said monomers selected from the group consisting of vinyl acetate, vinyl stearate, alkyl vinyl sulfone, styrene, vinyl benzoic acid, alkyl vinyl ether, maleic anhydride, vinyl chloride, and other olefins.

10. The method of claim 1 wherein the composition is applied as an aqueous dispersion or solution.

11. The method of claim 1 wherein the composition is applied by means of foam, nip, pad, kiss-roll, spray, dipping, immersion, and the like.

12. A substrate treated in accordance with the method of claim 1.

13. The substrate of claim 12 comprising a fibrous substrate.

14. The substrate of claim 13 which is a fiber, yarn, fabric, fabric blend, or textile.

15. The substrate of claim 14 which is woven, knit, or nonwoven fabric made from polyolefin fibers selected from the group consisting of polyethylene, polypropylene, and blends thereof.

16. The nonwoven fabric of claim 14 selected from the group consisting of spunbonded, meltblown, and laminates containing either spunbonded nonwoven or melt-blown nonwoven, or a combination thereof.
